(19) United States
(12) Patent Application Publication
(10) Pub. No.: US 2021/0188460 A1
(43) Pub. Date: Jun. 24, 2021

(54) AIRPORT MOBILITY SERVICES MANAGEMENT

(71) Applicant: AMADEUS S.A.S., Biot (FR)

(72) Inventors: Marcia Cristina Tessis De Castro, Amesbury, MA (US); Michele Christiana, Philadelphia, PA (US); Geoffrey Vanstaen, Waltham, MA (US); Sajjad Aziz, Everett, MA (US); Stephane Fohom Fotzo, Woburn, MA (US)

(21) Appl. No.: 17/125,049

(22) Filed: Dec. 17, 2020

Related U.S. Application Data
(60) Provisional application No. 62/951,544, filed on Dec. 20, 2019.

(51) Int. Cl. B64F 1/31; G06Q 10/02

(52) U.S. Cl. CPC B64F 1/31; G06Q 10/02

(57) ABSTRACT

Systems and methods for providing a centralized interface to facilitate end-to-end management of airport mobility services. A mobility request inventory of a mobility services platform is modified to register a mobility service request with the mobility services platform. A mobility resource is assigned to the mobility service request using location information of a passenger and a mobility resource inventory of the mobility services platform. A pickup request is transmitted to a ground handler system that identifies the mobility service request and the assigned mobility resource. A status of the mobility service request in a reservation record of the passenger based on data received from the ground handler system.

### TECHNICAL FIELD

The present invention relates generally to airport mobility service management, although not limited thereto. More specifically, the present invention relates to techniques of providing a centralized interface to facilitate end-to-end management of airport mobility services.

### BACKGROUND

Travel service providers (e.g., airlines) typically offer mobility services provided by independent operators (or ground handlers) to assist passengers with mobility limitations. In some instances, industry associations (e.g., International Air Transport Association (“IATA”)) establish standards that require the provisioning of mobility services to any passenger request such services. Managing mobility services in the travel industry may be challenging due to that independence of mobility service providers and travel service providers offering mobility services to its passengers. For example, passengers that submit mobility service requests to travel service providers generally do not know who will be providing that service or when that service will arrive. As another example, ground handlers experiencing a surge in demand for mobility services may be unable to provide service to passengers in a timely manner or notify particular passengers that are impacted by that surge in demand. In view of the above, improved techniques are needed to improve transparency and efficiency in managing mobility services provided in the travel industry.

### SUMMARY

In an embodiment, a system includes a processor and a computer-readable storage medium comprising instructions that upon execution by the processor cause the system to perform operations. The operations include modify a mobility request inventory of a mobility services platform to register a mobility service request with the mobility services platform, assign a mobility resource to the mobility service request using location information of a passenger and the mobility resource inventory of the mobility services platform, transmit a pickup request to a ground handler system that identifies the mobility service request and the assigned mobility resource, and update a status of the mobility service request in a reservation record of the passenger based on data received from the ground handler system.

In an embodiment, a method includes modifying, by a processor, a mobility request inventory of a mobility services platform to register a mobility service request with the mobility services platform, assigning, by the processor, a mobility resource to the mobility service request using location information of a passenger and the mobility resource inventory of the mobility services platform, transmitting, by the processor, a pickup request to a ground handler system that identifies the mobility service request and the assigned mobility resource, and updating, by the processor, a status of the mobility service request in a reservation record of the passenger based on data received from the ground handler system.

In an embodiment, a non-transitory computer-readable storage medium includes computer-readable instructions that upon execution by a processor of a computing device cause the computing device to modify a mobility request inventory of a mobility services platform to register a mobility service request with the mobility services platform, assign a mobility resource to the mobility service request using location information of a passenger and a mobility resource inventory of the mobility services platform, transmit a pickup request to a ground handler system that identifies the mobility service request and the assigned mobility resource, and update a status of the mobility service request in a reservation record of the passenger based on data received from the ground handler system.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The accompanying drawings, which are incorporated in and constitute a part of this specification, illustrate various embodiments of the present invention and, together with the general description of the invention given above, and the detailed description of the embodiments given below, explain the embodiments of the invention. In the drawings, like reference numerals are used to indicate like parts in the various views.

FIG. 1 is a block diagram of an example operating environment that is suitable for implementing aspects of the present invention.

FIG. 2 is a flow diagram depicting an example process of registering a mobility service request with a mobility services platform.

FIG. 3 is a flow diagram depicting an example process of providing a ground handler system with pre-departure notice of mobility service requests registered with a mobility services platform.

FIG. 4 is a flow diagram depicting an example process of triggering a dispatch of mobility services initiated at check-in.

FIG. 5 is a flow diagram depicting an example process of triggering a dispatch of mobility services initiated at flight arrival.

FIG. 6 is a flow diagram depicting an example process of providing centralized reporting data concerning mobility service requests.

FIG. 7 is a block diagram of an example computing environment suitable for use in implementing embodiments of the invention.

### DETAILED DESCRIPTION

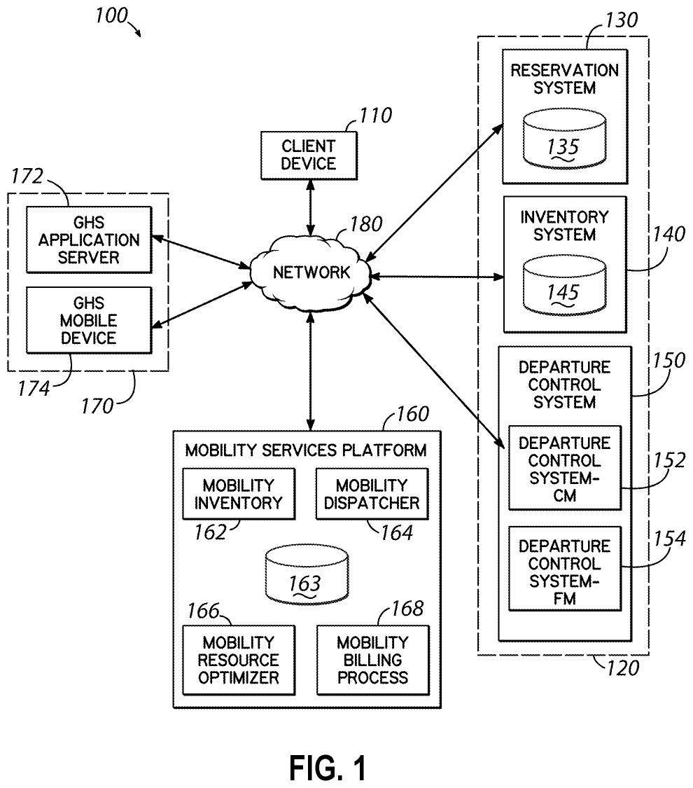

Techniques described herein relate to providing automated end-to-end management of airport mobility services. Referring to FIG. 1, an example operating environment for implementing aspects of the present invention is illustrated and designated generally 100. Operating environment 100 represents the various systems involved in providing mobility services (e.g., wheel chair) requested by users (e.g., customers or passengers) with existing travel reservations in the travel industry. In the example of FIG. 1, the travel services being provided relate to air travel. One skilled in the art will appreciate that travel services unrelated to air travel may be provided to passengers with existing travel reservations in accordance with the present invention. For example, travel services related to travel by bus, rail, car, boat, hotel shuttle services, and the like may also be provided to passengers with existing travel reservations in accordance with the present invention.

Operating environment 100 includes: client device 110, provider system 120, mobility services platform 160, and ground handler system (“GHS”) 170. FIG. 1 depicts the various computing devices as communicating with each other via networks (e.g., network 180), which may include one or more public and/or private networks. Examples of networks that are suitable for implementing network 180 include: local area networks (LANs), wide area networks (WANs), cellular networks, the Internet, and the like.

In operation, an end user interacts with provider system 120 using client device 110 to obtain data related to travel services (“travel-related data”) and services related to booking travel services (“travel-related services”) via network 180. Examples of travel-related data include inventory data, fare data, routing data, scheduling data, check-in data, boarding data, and the like. Examples of travel-related services include reserving travel services that define an itinerary, ticketing the reserved travel services that define an itinerary, and the like. For the purposes of the present disclosure, an “itinerary” refers to a structured travel route between an origin location and a destination location. Examples of systems suitable for implementing client device 110 include: a smartphone, a laptop, a personal computer, a mobile computing device, a tablet computer, a kiosk, a check-in desk computer, and the like.

Provider system 120 generally represents the various systems that a particular travel service provider employs to provide travel services to passengers with existing travel reservations. As shown in FIG. 1, provider system 120 includes: reservation system 130, inventory system 140, and departure control system (“DCS”) 150. In an embodiment, one or more of reservation system 130, inventory system 140, and DCS 150 are implemented using computing resources of a Global Distribution System (“GDS”), such as a GDS provided by Amadeus IT Group of Madrid, Spain, that is configured to provide travel-related data and travel-related services associated with multiple travel service providers.

Reservation records of the particular travel service provider are stored in database 135 under the control of reservation system 130. Reservation system 130 is configured to interact with external computing devices (e.g., client device 110) to process reservation requests received during a booking phase of a travel reservation process. In response to receiving a reservation request identifying a specific itinerary, reservation system 130 generates a reservation record in database 135. In an embodiment, the reservation record is a passenger name record (“PNR”). Each reservation record includes itinerary data and a record locator that uniquely identifies that reservation record in database 135. The record locator may also be referred to as a confirmation number, reservation number, confirmation code, booking reference, a PNR number, and the like.

Itinerary data generally includes travel information defining various travel services included in a specific itinerary and passenger information related to one or more passengers associated with the reservation record. Examples of travel information include: an origin location, a destination location, a departure date, a return date, a number in party, a booking class, a number of stops, a flight number, a travel provider identifier, a cabin class, and the like. Examples of passenger information, for each passenger among the one or more passengers associated with a reservation record, include: name, gender, date of birth, citizenship, home address, work address, passport information, an e-mail address, a phone number, a special service request (“SSR”), and the like.

Inventory data for the particular travel service provider is stored in database 145 under the control of inventory system 140. Examples of inventory data stored in database 145 includes inventory data related to: availability information that defines unreserved travel services inventory, aircraft for servicing specific segments of an airline route network operated by the particular travel service provider, spare parts for maintaining or repairing aircraft, in-flight refreshments, and the like. As used herein, “unreserved travel services inventory” relates to portions of a travel services inventory that are not associated with any reservation records stored in database 135. In contrast, “reserved travel services inventory” relates to portions of a travel services inventory that are associated with one or more reservation records stored in database 135.

Departure control system-customer management (“DCS-CM”) 152 manages passenger-related operations for the particular travel service provider at a specific airport. Such passenger-related operations generally include: interacting with a check-in device thereby enabling passengers with existing reservations to check-in for flights, issuing boarding cards to those passengers via the check-in device, updating reservations records associated with the existing reservations to reflect an appropriate status (e.g., checked-in, boarded, flown, etc.), facilitating a boarding process with a gate agent workstation or mobile device, generating passenger manifests for a particular flight, and the like. Check-in devices may include: a mobile device of a passenger, a self-service check-in kiosk, a check-in counter workstation, a gate agent workstation, and the like.

Departure control system-flight management (“DCS-FM”) 154 manages logistical-related operations for the particular travel service provider at a specific airport. Such logistical-related operations generally include interacting with inventory system 140 to assign an available aircraft for servicing a specific segment of an airline route network operated by the particular travel service provider. One skilled in the art will recognize that the process of assigning an aircraft to service a particular segment is typically referred to as a “tail assignment.” Logistical-related operations also include: assigning crew members to operate the assigned aircraft, identifying any SSRs annotated for a specific flight in reservation records stored in database 135 with reservation system 130, interacting with inventory system 140 to allocate available resources to satisfy such SSRs, determining appropriate load distributions for the assigned aircraft using data received from DCS-CM 152, and the like.

Mobility services platform 160 is generally configured to provide a centralized interface to facilitate end-to-end management of airport mobility services, as described in greater detail below. To that end, mobility services platform 160 includes: mobility inventory 162, database 163, mobility dispatcher 164, mobility resource optimizer 166, and mobility billing process 168.

Mobility inventory 162 is configured to manage data related to mobility service requests stored in a mobility request inventory and a mobility resource inventory of database 163. The mobility request inventory of database 163 is configured to store data related to each mobility service request registered with mobility services platform 160. Examples of data stored in mobility request inventory of database 163 for each mobility service request include: a record locator identifying a reservation record associated with the mobility request, passenger information from the reservation record, travel information from the reservation record, a request identifier assigned to the mobility service request, and the like.

The mobility resource inventory of database 163 is configured to store data related to each mobility service resource registered with mobility services platform for providing mobility services sought by mobility service requests. Examples of mobility service resources include: manual wheelchairs, GHS mobile devices associated with operators of mobility service resources, automated wheelchairs, baggage carts configured for attachment to other mobility service resources, airport carts for providing mobility services to multiple passengers, and the like. Examples of data stored in mobility resource inventory of database 163 for each mobility service resource include: configuration characteristics (e.g., size, weight, propulsion type, battery information, and the like), an operational state (e.g., functional or non-functional), current physical location, associated GHS (e.g., GHS 170), associated GHS mobile device (e.g. GHS mobile device 174), an assigned mobility resource identifier, and the like. In an embodiment, the mobility resource inventory is partitioned into an available mobility resource inventory and an unavailable mobility resource inventory. As used herein, “unavailable mobility resource inventory” relates to portions of the mobility service inventory that are assigned to mobility service requests stored in the mobility request inventory of database 163. In contrast, “available mobility resource inventory” relates to portions of the mobility resource inventory that are not assigned to any mobility service requests stored in the mobility request inventory of database 163.

Mobility dispatcher 164 is configured to initiate a dispatch process for each mobility service request registered with mobility services platform 160, as described in greater detail below. Mobility dispatcher initiates each dispatch process responsive to a trigger issued by another system of operating environment 100. By way of example, mobility dispatcher 164 may receive triggers from reservation system 130, inventory system 140, DCS 150, and/or GHS 170.

Mobility resource optimizer 166 is configured to interact with mobility inventory 162 to select a specific mobility service resource from available mobility resource inventory to satisfy a given assignment request sent by mobility dispatcher 164 using an optimization function. In selecting the specific mobility service resource, the optimization function considers such factors as location information for each mobility service resource in available mobility resource inventory, a current location of a passenger associated with the given assignment request, location information for a pick-up location and/or a drop-off location associated with the given assignment request, and the like.

Mobility billing process and reporting process (“mobility billing process”) 168 is generally configured as a centralized source of reporting data concerning mobility service requests. To that end, mobility billing process 168 retrieves data concerning mobility service requests registered with mobility service platform 160 by querying mobility inventory 162. Each query may include one or more criteria that limit data requested by that query to data concerning mobility service requests: associated with a particular status (e.g., a “completed” status), at a given airport, at a given terminal at the given airport, for a given flight number, on a given date, and the like. Mobility billing process 168 also compiles reporting data based on data received from mobility inventory 162 responsive to queries. Examples of information provided by reporting data includes: mobility resource usage per provider system (e.g., an airline), mobility resource usage per airport, average response times of particular GHSs (e.g., GHS 170), and the like.

In operating environment 100, GHS 170 represents a remote computing system operated by an independent provider of mobility services for passengers on behalf of one or more travel service providers. As seen in FIG. 1, GHS 170 includes GHS application server 172 and GHS mobile device 174. GHS application server 172 is configured to provide an interface for exchanging communications related to mobility service requests, as described in greater detail below. By way of example, GHS application server 172 interacts with mobility service platform 160 for scheduling of mobility service resources to satisfy mobility service requests submitted by passengers. As another example, GHS application server 172 communicates dispatch requests sent by mobility service platform 160 to one or more GHS mobile devices (e.g., GHS mobile device 174) associated with a mobility service resource (e.g., an automated wheelchair) or an operator of a mobility service resource. GHS mobile device 174 is configured to interact with GHS application server 172 to obtain dispatch requests related to mobility service requests and provide status update information concerning mobility service requests, as described in greater detail below. Examples of systems suitable for implementing GHS mobile device 174 include: a smartphone, a laptop, a personal computer, a mobile computing device, a tablet computer, and the like.

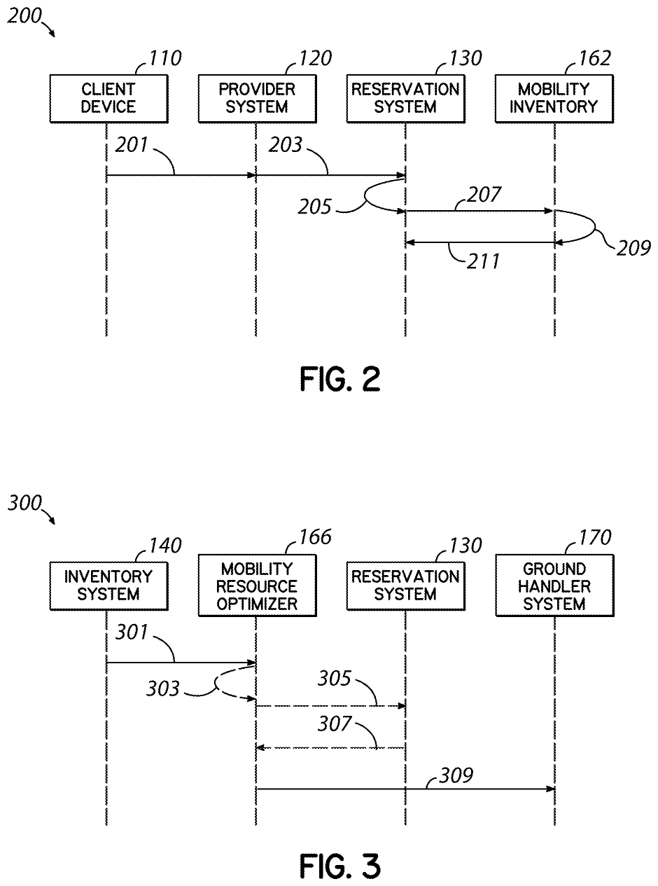

FIG. 2 is a flow diagram illustrating an example process 200 of registering a mobility service request with a mobility services platform. In the example of FIG. 2, the mobility service request is registered with a mobility services platform during a booking phase of a travel reservation process. However, in accordance with embodiments of the present disclosure, mobility service request may be registered with a mobility services platform at other times. For example, a mobility service request may be registered with a mobility services platform at check-in. At step 201, an end user submits a mobility service request to a web interface of provider system 120 while booking a travel itinerary using client device 110. At step 203, provider system 120 forwards the mobility service request to reservation system 130 for processing by a travel reservation process initiated by reservation system 130 for booking the travel itinerary.

At step 205, the travel reservation process of reservation system 130 creates an SSR field in a reservation record generated for booking the travel itinerary in database 135 and populates the SSR field with a mobility services identifier corresponding to the mobility service request. At step 207, reservation system sends a service request notification to mobility inventory 162 comprising the mobility services identifier. In an embodiment, the service request notification further comprises passenger information and/or travel information from the reservation record. At step 209, mobility inventory 162 modifies a mobility request inventory stored in database 163 based on the mobility service request thereby registering the mobility service request with mobility services platform 160. At step 211, mobility inventory 162 sends an acknowledgement message to reservation system 130 that confirms registration of the mobility service request with mobility services platform 160. In an embodiment, reservation system 130 modifies the reservation record based on the acknowledgement message. By way of example, reservation system 130 may modify a flag value of the reservation record to transition a status of the SSR field to a “confirmed” status.

FIG. 3 is a flow diagram illustrating an example process 300 of providing a ground handler system with pre-departure notice of mobility service requests registered with a mobility services platform. At step 301, inventory system 140 issues a trigger to mobility resource optimizer 166 responsive to a determination that a current system time of inventory system 140 corresponds to a pre-defined time. In an embodiment, the pre-defined time is a start time of a pre-departure window. As used herein, a “pre-departure window” is a period of time defined with respect to a departure time of an aircraft servicing a specific segment of an airline route network operated by a particular travel service provider. In an embodiment, the pre-defined time is set by an administrator of inventory system 140 to schedule pre-departure notifications for ground handler system 170 on a periodic basis (e.g., daily, weekly, and the like). The trigger that inventory system 140 issues at step 301 causes mobility resource optimizer 166 to compile a list of mobility service requests registered with mobility services platform 160 at a pre-configured granularity. In an embodiment, the pre-configured granularity is with respect to mobility service requests registered with mobility services platform 160: at a given airport, at a given terminal at the given airport, for a given flight number, on a given date, or a combination thereof.

From step 301, process 300 proceeds either to step 303 or alternatively to step 305. At step 303 and responsive to the trigger, mobility resource optimizer 166 compiles the list of mobility service requests registered with mobility services platform 160 at the pre-configured granularity by identifying mobility services requests stored in mobility request inventory in database 163 that meet criteria defined by the pre-configured granularity. From step 303, process 300 proceeds to step 309. At step 305 and responsive to the trigger, mobility resource optimizer 166 compiles the list of mobility service requests registered with mobility services platform 160 at the pre-configured granularity by querying reservation system 130. In particular, at step 305, mobility resource optimizer 166 submits a query to reservation system 130 requesting data concerning mobility service requests in reservation records stored in database 135 that meet criteria defined by the pre-configured granularity. At step 307, reservation system 130 transmits a response to mobility resource optimizer 166 that includes the data concerning mobility service requests sought by the query. From step 307, process 300 proceeds to step 309.

At step 309, mobility resource optimizer 166 communicates the list of mobility service requests at the pre-configured granularity to ground handler system 170 for further processing. In an embodiment, mobility resource optimizer 166 communicates the list of mobility service requests to ground handler system 170 in an extended markup language (“XML”) message. In an embodiment, mobility resource optimizer 166 communicates the list of mobility service requests to ground handler system 170 via an email message in accordance with a Simple Mail Transfer Protocol (“SMTP”).

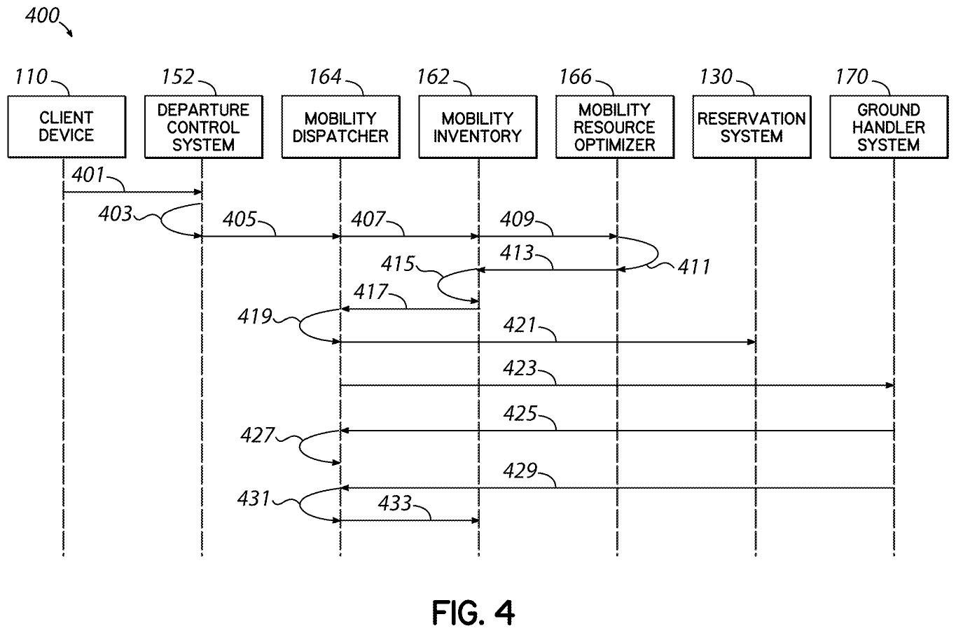

FIG. 4 is a flow diagram illustrating an example process 400 of triggering a dispatch of mobility services initiated at check-in. At step 401, DCS-CM 152 receives input indicative of an interaction with a check-in device by a passenger to check-in for a flight included in an itinerary of the passenger. In an embodiment, the input comprises a record locator identifying a reservation record that defines the itinerary of the passenger. In an embodiment, the check-in device is a mobile device (e.g., client device 110 of FIG. 1) of the passenger, a self-service check-in kiosk, a check-in counter workstation, or a gate agent workstation. At step 403, DCS-CM 152 determines that the passenger is associated with a mobility service request. In an embodiment, DCS-CM 152 determines that the passenger is associated with a mobility service request by querying reservation system 130 with data derived from the input. In an embodiment, DCS-CM 152 determines that the passenger is associated with a mobility service request by querying mobility inventory 162 with data derived from the input.

At step 405, DCS-CM 152 transmits a dispatch message to mobility dispatcher 264 that includes a current location of the passenger and travel information included in a reservation record defining the itinerary of the passenger. In an embodiment, the current location of the passenger is determined using a physical location of the check-in device. At step 407 and responsive to the dispatch message, mobility dispatcher 164 initiates a dispatch process for the mobility request by submitting an assignment request to mobility inventory 162. The assignment request submitted by mobility dispatcher 164 at step 407 includes the current location of the passenger and the travel information (e.g., a flight number, a gate number assigned to the flight number, and the like). At step 409, mobility inventory 162 forwards the assignment request to mobility resource optimizer 166.

At step 411, mobility resource optimizer 166 selects a specific mobility resource from available mobility resource inventory in database 163 to satisfy the assignment request. In an embodiment, mobility resource optimizer 166 selects the specific mobility resource based on a comparison between location information for the specific mobility resource and one or more of the current location of the passenger and location information for the flight. In an embodiment, the location information for the specific mobility resource is determined using database 163. In an embodiment, the location information for the specific mobility resource is determined using a signal transmitted by the specific mobility resource. In an embodiment, the location information for the flight is determined using the travel information. In an embodiment, the location information for the flight is determined by querying DCS-FM 154.

At step 413, mobility resource optimizer 166 transmits an assignment response to mobility inventory 162 identifying the specific mobility resource for assignment to the mobility service request. At step 415, mobility inventory 162 modifies database 163 to update a status of the specific mobility resource to an “unavailable” status thereby reducing available mobility resource inventory in database 163. In an embodiment, mobility inventory 162 modifies database 163 at step 415 by transitioning the specific mobility resource from the available mobility resource inventory to unavailable mobility resource inventory of database 163. At step 417, mobility inventory 162 forwards the assignment response to mobility dispatcher 164. At step 419, mobility dispatcher 164 updates a status of the mobility request in mobility request inventory of database 163 to an “assigned” status. At step 421, mobility dispatcher 164 transmits an assignment notification to reservation system 130 comprising the travel information and/or passenger information included in the reservation record to confirm that mobility resource inventory has been assigned to the mobility service request. In an embodiment, the assignment notification further comprises a record locator identifying the reservation record. In an embodiment, reservation system 130 is configured to transition a status of an SSR field created in the reservation record for the mobility service request to a “dispatched” status.

At step 423, mobility dispatcher 164 transmits a pickup request to GHS 170 comprising data that identifies: the mobility service request, the specific mobility resource assigned to the mobility service request, the current location of the passenger. In an embodiment, mobility dispatcher 164 transmits the pickup request to a GHS mobile device 174 of GHS 170 that is associated with the specific mobility resource. In an embodiment, mobility dispatcher 164 transmits the pickup request to GH application server 172 of GHS 170. At step 425, GHS 170 transmits a pickup notification to mobility dispatcher 164 to confirm that the specific mobility resource has reached the current location of the passenger to provide mobility assistance. In an embodiment, the GHS mobile device 174 that is associated with the specific mobility resource transmits the pickup notification to mobility dispatcher 164. In an embodiment, GH application server 172 transmits the pickup notification to mobility dispatcher 164. At step 427 and responsive to the pickup notification, mobility dispatcher 164 transitions the status of the mobility request in the mobility request inventory of database 163 from the “assigned” status to an “in-transit” status. At step 429, GHS 170 transmits a drop-off notification to mobility dispatcher 164 to confirm that the specific mobility resource has reached a drop-off location identified in the mobility service request. In an embodiment, the GHS mobile device 174 that is associated with the specific mobility resource transmits the drop-off notification to mobility dispatcher 164. In an embodiment, GH application server 172 transmits the drop-off notification to mobility dispatcher 164. At step 431 and responsive to the drop-off notification, mobility dispatcher 164 transitions the status of the mobility request in the mobility request inventory of database 163 from the “in-transit” status to a “completed” status. At step 433, mobility dispatcher 164 forwards the drop-off notification to mobility inventory 162. In an embodiment, mobility inventory 162 is configured to transition a specific mobility resource associated with a drop-off notification from unavailable mobility resource inventory of database 163 to available mobility resource inventory responsive to the drop-off notification.

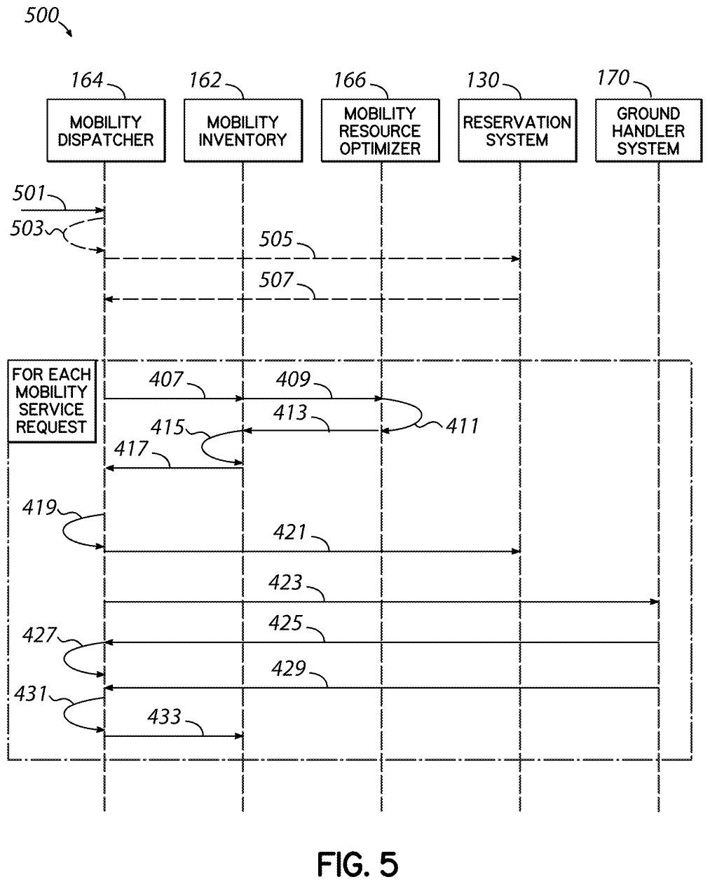

FIG. 5 is a flow diagram illustrating an example process 500 of triggering a dispatch of mobility services initiated at flight arrival. At step 501, mobility dispatcher 164 receives a trigger corresponding to an arrival time of a flight. In an embodiment, mobility dispatcher 164 receives the trigger responsive to a determination by inventory system 140 that a current system time of inventory system 140 corresponds to a pre-defined time. In an embodiment, the pre-defined time is a start time of a pre-arrival window. As used herein, a “pre-arrival window” is a period of time defined with respect to an arrival time of an aircraft servicing a specific segment of an airline route network operated by a particular travel service provider. In an embodiment, the pre-defined time is set by an administrator of inventory system 140 to schedule pre-arrival notifications for GHS 170 based on an average response time of GHS 170, a current volume of mobility services requests being handled by GHS 170, or a combination thereof. In an embodiment, the average response time of GHS 170 corresponds to an average time interval between a time a pickup request for a given mobility service request is transmitted from mobility dispatcher 164 to GHS 170 and a time that a pickup notification associated with that pickup request is received by mobility dispatcher 164. In an embodiment, receives the trigger responsive to a determination by DCS-FM 154 that the flight has received a gate assignment at an arrival airport.

In response to the dispatch message received at step 501, mobility dispatcher 164 is configured to compile a list of mobility service requests registered with mobility services platform 160 that are associated with the flight. From step 501, process 500 proceeds either to step 503 or alternatively to step 505. At step 503 and responsive to the trigger, mobility dispatcher 164 compiles the list of mobility service requests registered with mobility services platform 160 by identifying mobility service requests stored in mobility request inventory in database 163 that that are associated with the flight. From step 503, process 500 proceeds to step 409. At step 505 and responsive to the trigger, mobility dispatcher 164 compiles the list of mobility service requests registered with mobility services platform 160 that that are associated with the flight by querying reservation system 130. In particular, at step 505, mobility dispatcher 164 submits a query to reservation system 130 seeking data concerning mobility service requests in reservation records stored in database 135 that are associated with the flight. At step 507, reservation system 130 transmits a response to mobility dispatcher 164 that includes the data concerning mobility service requests sought by the query. From step 507, process 500 proceeds to step 407. As seen in FIG. 5, for each mobility service request included in the list of mobility service requests compiled by mobility dispatcher process 500 includes steps 407-433 from process 400 of FIG. 4.

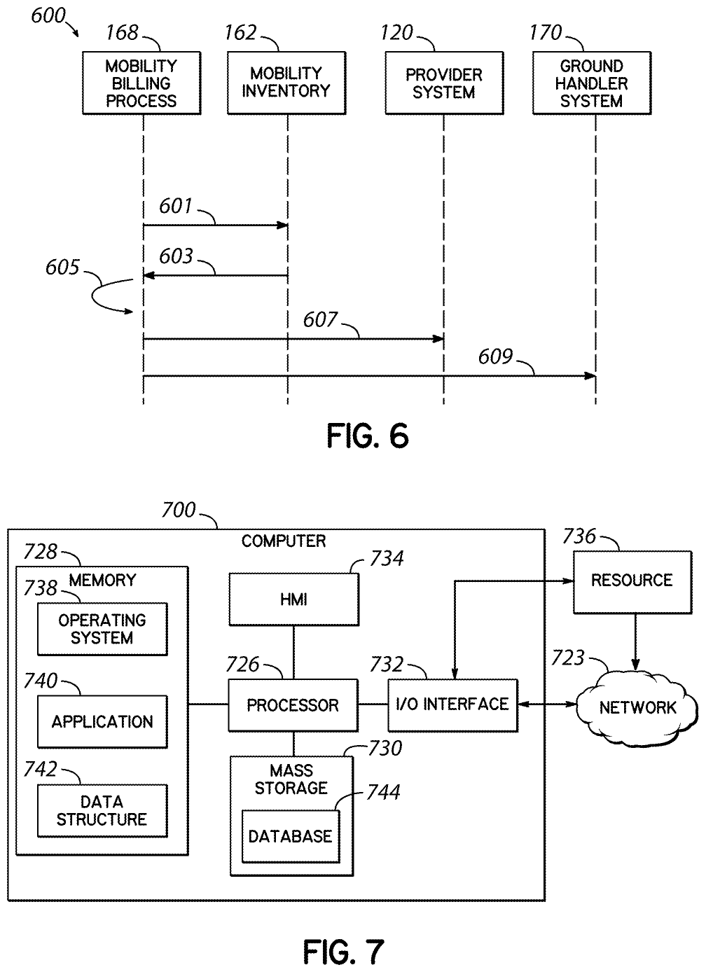

FIG. 6 is a flow diagram depicting an example process 600 of providing centralized reporting data concerning mobility service requests. At step 601, mobility billing process 168 transmits a query to mobility inventory 162 requesting data concerning each mobility service request in mobility request inventory of database 163 that is associated with a “completed” status. In an embodiment, the query includes one or more additional criterion that limit the requested data to data concerning mobility service requests: at a given airport, at a given terminal at the given airport, for a given flight number, on a given date, or a combination thereof. At step 603, mobility billing process 168 receives a response from mobility inventory 162 that includes the data requested in the query. At step 605, mobility billing process compiles first reporting data and second reporting data based on the data included in the response from mobility inventory 162. In an embodiment, the first reporting data is compiled in a format specified by an administrator of provider system 120. In an embodiment, the second reporting data is compiled in a format specified by an administrator of GHS 170. In an embodiment, the first reporting data and/or the second reporting data includes: billing information related to mobility service requests, statistical information related to mobility service requests (e.g., average response times), or a combination thereof. At step 607, mobility billing process 168 pushes the first reporting data to provider system 120. As used herein, “push” refers to a first computing device automatically transmitting data to a second computing device in accordance with computer-readable instructions executed by one or more processors of the first computing device. At step 609, mobility billing process 168 pushes the second reporting data to GHS 170.

Having described various embodiments of the invention, an exemplary computing environment suitable for implementing embodiments of the invention is now described. With reference to FIG. 7, client device 110, provider system 120, reservation system 130, inventory system 140, DCS 150, DCS-CM 152, DCS-FM 154, mobility services platform 160, mobility inventory 162, mobility dispatcher 164, mobility resource optimizer 166, mobility billing process 168, GHS 170, GHS application server 172, and GHS mobile device 174 may be implemented on one or more computer devices or systems, such as exemplary computer system 700. The computer system 700 may include a processor 726, a memory 728, a mass storage memory device 730, an input/output (I/O) interface 732, and a Human Machine Interface (HMI) 734. The computer system 700 may also be operatively coupled to one or more external resources 736 via the network 723 or I/O interface 732. External resources 736 may include, but are not limited to, servers, databases, mass storage devices, peripheral devices, cloud-based network services, or any other suitable computer resource that may be used by the computer system 700.

The processor 726 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 728. The memory 728 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 730 may include data storage devices such as a hard drive, optical drive, tape drive, non-volatile solid state device, or any other device capable of storing information.

The processor 726 may operate under the control of an operating system 738 that resides in the memory 728. The operating system 738 may manage computer resources so that computer program code embodied as one or more computer software applications, such as an application 740 residing in memory 728, may have instructions executed by the processor 726. In an alternative embodiment, the processor 726 may execute the application 740 directly, in which case the operating system 738 may be omitted. One or more data structures 742 may also reside in memory 728, and may be used by the processor 726, operating system 738, or application 740 to store or manipulate data.

The I/O interface 732 may provide a machine interface that operatively couples the processor 726 to other devices and systems, such as the network 723 or the one or more external resources 736. The application 740 may thereby work cooperatively with the network 723 or the external resources 736 by communicating via the I/O interface 732 to provide the various features, functions, applications, processes, or modules comprising embodiments of the invention. The application 740 may also have program code that is executed by the one or more external resources 736, or otherwise rely on functions or signals provided by other system or network components external to the computer system 700. Indeed, given the nearly endless hardware and software configurations possible, persons having ordinary skill in the art will understand that embodiments of the invention may include applications that are located externally to the computer system 700, distributed among multiple computers or other external resources 736, or provided by computing resources (hardware and software) that are provided as a service over the network 723, such as a cloud computing service.

The HMI 734 may be operatively coupled to the processor 726 of computer system 700 in a known manner to allow a user to interact directly with the computer system 700. The HMI 734 may include video or alphanumeric displays, a touch screen, a speaker, and any other suitable audio and visual indicators capable of providing data to the user. The HMI 734 may also include input devices and controls such as an alphanumeric keyboard, a pointing device, keypads, pushbuttons, control knobs, microphones, etc., capable of accepting commands or input from the user and transmitting the entered input to the processor 726.

A database 744 may reside on the mass storage memory device 730, and may be used to collect and organize data used by the various systems and modules described herein. The database 744 may include data and supporting data structures that store and organize the data. In particular, the database 744 may be arranged with any database organization or structure including, but not limited to, a relational database, a hierarchical database, a network database, or combinations thereof. In an embodiment, database 135, database 145, and/or database 163 of FIG. 1 may be implemented using one or more databases, such as exemplary database 744. A database management system in the form of a computer software application executing as instructions on the processor 726 may be used to access the information or data stored in records of the database 744 in response to a query, where a query may be dynamically determined and executed by the operating system 738, other applications 740, or one or more modules.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed:

1. A system comprising:
a processor; and
a computer-readable storage medium comprising instructions that upon execution by the processor cause the system to perform operations, the operations comprising:
modify a mobility request inventory of a mobility services platform to register a mobility service request with the mobility services platform;
assign a mobility resource to the mobility service request using location information of a passenger and a mobility resource inventory of the mobility services platform;
transmit a pickup request to a ground handler system that identifies the mobility service request and the mobility resource; and
update a status of the mobility service request in a reservation record of the passenger based on data received from the ground handler system.

2. The system of claim 1 wherein the mobility resource is assigned to the mobility service request responsive to receiving a dispatch message from a departure control system that comprises information indicative of an interaction with a check-in device by the passenger to check-in.

3. The system of claim 1 wherein the operations further comprise:
receive a trigger that corresponds to an arrival time of a flight,
wherein the mobility resource is assigned to the mobility service request in response to receiving the trigger.

4. The system of claim 1 wherein the mobility resource is a manual wheelchair, a ground handler system mobile device, an automated wheelchair, a baggage cart, or a multiple-passenger airport cart.

5. The system of claim 1 wherein the mobility service request comprises a record locator identifying the reservation record associated the mobility service request, passenger information from the reservation record, travel information from the reservation record, or a request identifier assigned to the mobility service request.

6. The system of claim 1 wherein the mobility resource inventory comprises configuration characteristics for the mobility resource, an operational state for the mobility resource, a current physical location mobility resource, an associated ground handler system, an associated ground handler system mobile device, or an assigned mobility resource identifier.

7. The system of claim 1 wherein the mobility resource inventory is partitioned into an available mobility resource inventory and an unavailable mobility resource inventory, and the operations further comprise:
transition the mobility resource from the available mobility resource inventory to the unavailable mobility resource inventory in response the mobility resource being assigned to the mobility service request.

8. The system of claim 1 wherein the pickup request further comprises a current location of the passenger.

9. The system of claim 1 wherein the mobility service request comprises a drop-off location, and the operations further comprise:
receive a drop-off notification that confirms that the mobility resource has reached the drop-off location.

10. A method comprising:
modifying, by a processor, a mobility request inventory of a mobility services platform to register a mobility service request with the mobility services platform;
assigning, by the processor, a mobility resource to the mobility service request using location information of a passenger and a mobility resource inventory of the mobility services platform;
transmitting, by the processor, a pickup request to a ground handler system that identifies the mobility service request and the mobility resource; and
updating, by the processor, a status of the mobility service request in a reservation record of the passenger based on data received from the ground handler system.

11. The method of claim 10 wherein the mobility resource is assigned to the mobility service request responsive to receiving a dispatch message from a departure control system that comprises information indicative of an interaction with a check-in device by the passenger to check-in.

12. The method of claim 10 further comprising:
receiving a trigger at the processor that corresponds to an arrival time of a flight,
wherein the mobility resource is assigned to the mobility service request in response to receiving the trigger.

13. The method of claim 12 wherein the trigger is received in response to the flight receiving a gate assignment at an arrival airport.

14. The method of claim 10 wherein the mobility resource is a manual wheelchair, a ground handler system mobile device, an automated wheelchair, a baggage cart, or a multiple-passenger airport cart.

15. The method of claim 10 wherein the mobility service request comprises a record locator identifying the reservation record associated the mobility service request, passenger information from the reservation record, travel information from the reservation record, or a request identifier assigned to the mobility service request.

16. The method of claim 10 wherein the mobility resource inventory comprises configuration characteristics for the mobility resource, an operational state for the mobility resource, a current physical location mobility resource, an associated ground handler system, an associated ground handler system mobile device, or an assigned mobility resource identifier.

17. The method of claim 10 wherein the mobility resource inventory is partitioned into an available mobility resource inventory and an unavailable mobility resource inventory, and further comprising:
transitioning the mobility resource from the available mobility resource inventory to the unavailable mobility resource inventory in response the mobility resource being assigned to the mobility service request.

18. The method of claim 10 wherein the pickup request further comprises a current location of the passenger.

19. The method of claim 10 wherein the mobility service request comprises a drop-off location, and further comprising:
receiving a drop-off notification that confirms that the mobility resource has reached the drop-off location.

20. A non-transitory computer-readable storage medium comprising computer-readable instructions that upon execution by a processor of a computing device cause the computing device to:
modify a mobility request inventory of a mobility services platform to register a mobility service request with the mobility services platform;
assign a mobility resource to the mobility service request using location information of a passenger and a mobility resource inventory of the mobility services platform;
transmit a pickup request to a ground handler system that identifies the mobility service request and the mobility resource; and
update a status of the mobility service request in a reservation record of the passenger based on data received from the ground handler system.
